(19) United States
(12) Patent Application Publication
(10) Pub. No.: US 2002/0179115 A1
(43) Pub. Date: Dec. 5, 2002

(54) Cloth pouch attachment for a scrub brush

(76) Inventor: Angelo Alex, Joliet, IL (US)

Correspondence Address: Richard W. Goldstein, 2071 Clove Road, Staten Island, NY, 10304, US

(21) Appl. No.: 09/872,025

(22) Filed: Jun. 1, 2001

(51) Int. Cl. B08B 1/00; A46B 17/04

(52) U.S. Cl. 134/6; 15/247

(57) ABSTRACT

A cloth pouch attachment for a scrub brush including an expandable pouch portion dimensioned for receiving a head portion of a scrub brush therein. The pouch portion has an open upper end for receiving the head portion therein. The pouch portion is comprised of a soft cloth material. The bristles are inserted into the pouch portion and the pouch is cinched on the head portion of the scrub brush. The soft cloth material will protect the finish of an automobile from being scratched by the scrub brush when it is used to clean the scratchable surface of the automobile.

### CROSS REFERENCES AND RELATED SUBJECT MATTER

This application relates to subject matter contained in patent application Ser. No. 09/545,901, filed in the United States Patent Office on Apr. 8, 2000.

### BACKGROUND OF THE INVENTION

The present invention relates to a cloth pouch attachment for a scrub brush and more particularly pertains to covering the bristles of a carwash scrub brush to avoid scratching a vehicle while washing.

The use of washing brushes is known in the prior art. More specifically, washing brushes heretofore devised and utilized for the purpose of cleaning and scrubbing selected items are known to consist basically of familiar, expected and obvious structural configurations, notwithstanding the myriad of designs encompassed by the crowded prior art which have been developed for the fulfillment of countless objectives and requirements.

By way of example, U.S. Pat. No. 4,673,307 to Prestele discloses a washing brush with an adjustable head portion. U.S. Pat. Nos. 5,730,644 to Pfanstiehl and 5,718,275 to Williams disclose various vehicle related devices.

While these devices fulfill their respective, particular objective and requirements, the aforementioned patents do not describe a cloth pouch attachment for a scrub brush for covering the bristles of a carwash scrub brush to prevent scratching a vehicle while washing.

In this respect, the cloth pouch attachment for a scrub brush according to the present invention substantially departs from the conventional concepts and designs of the prior art, and in doing so provides an apparatus primarily developed for the purpose of covering the bristles of a carwash scrub brush to prevent scratching a vehicle while washing.

Therefore, it can be appreciated that there exists a continuing need for a new and improved cloth pouch attachment for a scrub brush which can be used for covering the bristles of a carwash scrub brush to prevent scratching a vehicle while washing. In this regard, the present invention substantially fulfills this need.

### SUMMARY OF THE INVENTION

In the view of the foregoing disadvantages inherent in the known types of washing brushes now present in the prior art, the present invention provides an improved cloth pouch attachment for a scrub brush. As such, the general purpose of the present invention, which will be described subsequently in greater detail, is to provide a new and improved cloth pouch attachment for a scrub brush which has all the advantages of the prior art and none of the disadvantages.

To attain this, the present invention essentially comprises an expandable pouch portion dimensioned for receiving the head portion of the scrub brush therein. The pouch portion has an open upper end for receiving the head portion therein. The pouch portion is comprised of a soft cloth material. The open upper end has a peripheral channel extending therearound. The peripheral channel has an input opening and an output opening in relative proximity to one another. The input opening and the output opening each are supported by a gusset. A cinching string is disposed within the peripheral channel of the open upper end of the expandable pouch portion. The cinching string has a first end portion extending through the input opening and traversing the peripheral channel and extending outwardly of the output opening. The cinching string has a second end portion essentially aligned with the first end portion. The first end portion and the second end portion are coupled together by a clip. The clip is movable with respect to the first end portion and the second end portion whereby upward movement thereof will serve to close up the open upper end of the expandable pouch portion.

There has thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

It is therefore an object of the present invention to provide a new and improved cloth pouch attachment for a scrub brush which has all the advantages of the prior art washing brushes and none of the disadvantages.

It is another object of the present invention to provide a new and improved cloth pouch attachment for a scrub brush which may be easily and efficiently manufactured and marketed.

It is a further object of the present invention to provide a new and improved cloth pouch attachment for a scrub brush which is of durable and reliable construction.

An even further object of the present invention is to provide a new and improved cloth pouch attachment for a scrub brush which is susceptible of a low cost of manufacture with regard to both materials and labor, and which accordingly is then susceptible of low prices of sale to the consuming public, thereby making such a cloth pouch attachment for a scrub brush economically available to the buying public.

Even still another object of the present invention is to provide a new and improved cloth pouch attachment for a scrub brush for covering the bristles of a carwash scrub brush to prevent scratching a vehicle while washing.

Lastly, it is an object of the present invention to provide a new and improved cloth pouch attachment for a scrub brush including an expandable pouch portion dimensioned for receiving the head portion of the scrub brush therein. The pouch portion has an open upper end for receiving the head portion therein. The pouch portion is comprised of a soft cloth material.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a perspective view of the preferred embodiment of the cloth pouch attachment for a scrub brush constructed in accordance with the principles of the present invention.

FIG. 2 is a front of the present invention illustrated with the scrub brush positioned therein.

FIG. 3 is an isolated front view of a second embodiment of the present invention.

The same reference numerals refer to the same parts through the various figures.

### DESCRIPTION OF THE PREFERRED EMBODIMENT

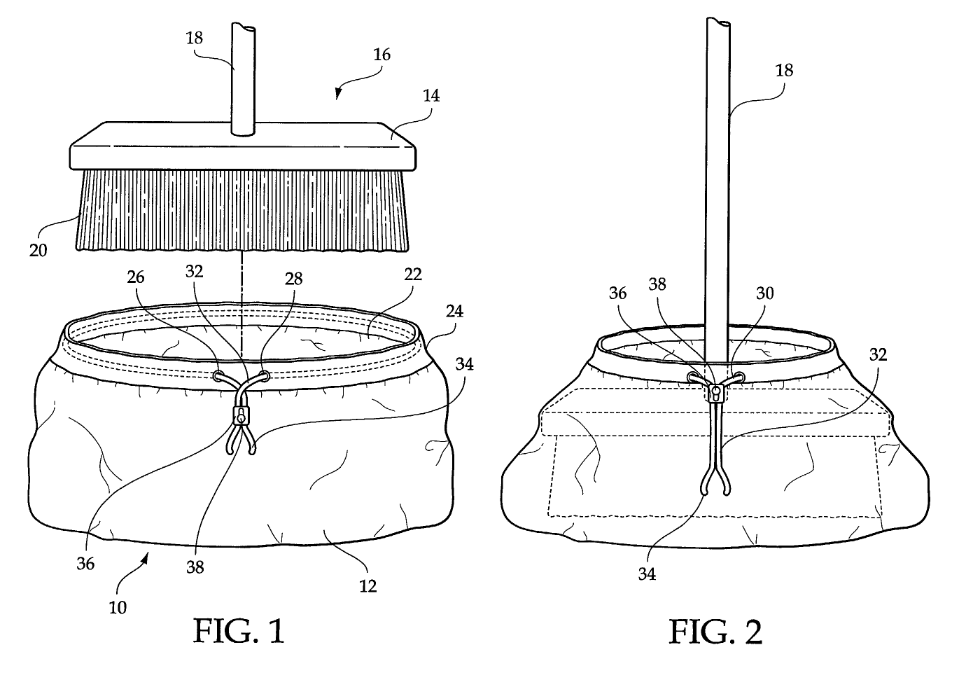

With reference now to the drawings, and in particular, to FIGS. 1 through 3 thereof, the preferred embodiment of the new and improved cloth pouch attachment for a scrub brush embodying the principles and concepts of the present invention and generally designated by the reference number 10 will be described.

Specifically, it will be noted in the various Figures that the device relates to a cloth pouch attachment for a scrub brush for covering the bristles of a carwash scrub brush to prevent scratching a vehicle while washing. In its broadest context, the device consists of an expandable pouch portion and a cinching string. Such components are individually configured and correlated with respect to each other so as to attain the desired objective.

The expandable pouch portion 12 is dimensioned for receiving the head portion 14 of the scrub brush 16 therein. The scrub brush 16 includes a shaft 18 extending upwardly from the head portion 14. As shown, the head portion 14 includes a broad flange of a substantially rectangular configuration with a substantially flat planar top surface. The head portion 14 also includes a plurality of semi-rigid bristles 20 extending downwardly therefrom. Note FIG. 1. The pouch portion 12 has an open upper end 22 for receiving the head portion 14 therein. The pouch portion 12 is comprised of a soft cloth material. The soft cloth material is preferable to prevent unwanted scratching of a scratchable cleaning surface, such as the paint finish of an automobile that sometimes can occur when washing the automobile using the scrub brush 16. The open upper end 22 has a peripheral channel 24 extending therearound. The peripheral channel 24 has an input opening 26 and an output opening 28 in relative proximity to one another. The input opening 26 and the output opening 28 each are supported by a gusset.

The cinching string 30 is disposed within the peripheral channel 24 of the open upper end 22 of the expandable pouch portion 12. The cinching string 30 has a first end portion 32 extending through the input opening 26 and traversing the peripheral channel 24 and extending outwardly of the output opening 28. The cinching string 30 has a second end portion 34 essentially aligned with the first end portion 32. The first end portion 32 and the second end portion 34 are coupled together by a clip 36. The clip 36 is movable with respect to the first end portion 32 and the second end portion 34 whereby upward movement thereof toward the input opening 26 and output opening 28 while pulling the cinching string 30 away from the input opening 26 and output opening 28 will serve to close up the open upper end 22 of the expandable pouch portion 12. Additionally, the clip 36 could be provided with a lock 38, the will serve to prevent its movement once in position. The lock 38 is preferably a slide-type lock that can simply be manually moved from a locked to an unlocked orientation. Compare FIG. 1 (unlocked) with FIG. 2 (locked).

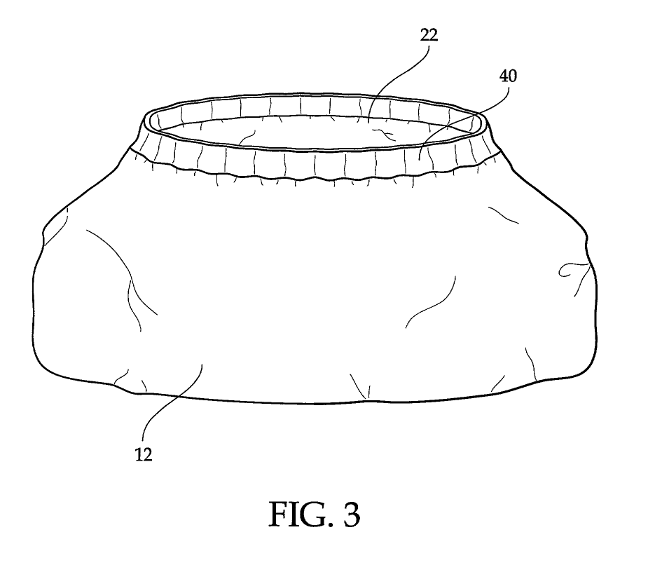

In an alternate embodiment, as illustrated in FIG. 3, the peripheral channel 24 and the cinching string are replaced with an elastic band 40. The elastic band 40 will merely expand and contract the open upper end 22 of the pouch portion 12 to accommodate the head portion 14 of the scrub brush 16.

In use, the bristles are inserted through the open upper end of the expandable pouch such that the open upper end is pulled over the broad flange. The cinching string is pulled to close the expandable pouch over the broad flange of the head portion of the brush to secure the expandable pouch thereon. Accordingly, when soft cotton material of the pouch portion 12 is used to clean the scratchable cleaning surface, the automobile owner is provided with peace of mind when washing their car because the bristles 20 of the scrub brush 16 will not adversely affect the finish on the car during manual washing.

As to the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and the manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modification and changes will readily occur to those skilled in the art, it is not desired to limit the invention to the exact construction and operation shown and described, and accordingly, all suitable modification and equivalents may be resorted to, falling within the scope of the invention.

What is claimed as being new and desired to be protected by Letters Patent of the United States is as follows:

1. A scrub brush cleaning method, for use with a scrub brush having a handle portion, and a head portion having a broad flange and bristles extending from said broad flange, in allowing the scrub brush to be used to clean a scratchable cleaning surface, comprising the steps of:
providing an expandable pouch made of soft cloth material, the expandable pouch having an open upper end and a cinching string at said open upper end;
extending the bristles through the open upper end of the pouch;
pulling the open upper end over the broad flange of the head portion;
securing the expandable pouch onto the open upper end by pulling the string to cinch the open end above the broad flange; and
cleaning the scratchable cleaning surface with the soft cloth material.

2. The scrub brush cleaning method as recited in claim 1, wherein the open upper end of the pouch portion has a peripheral channel extending therearound, the peripheral channel having an input opening and an output opening in relative proximity to one another, the cinching string disposed within the peripheral channel of the open upper end of the expandable pouch portion, the cinching string has a first end portion extending through the input opening and traversing the peripheral channel and extending outwardly of the output opening, the cinching string having a second end portion essentially aligned with the first end portion, and wherein the step of pulling the string to cinch the open end further comprises pulling the first end and second end portion away from both the input and output openings.

3. The cloth pouch attachment for a scrub brush as set forth in claim 2 wherein the first end portion and the second end portion of the cinching string are coupled together by a clip, the clip being movable with respect to the first end portion and the second end portion whereby upward movement thereof will serve to close up the open upper end of the expandable pouch portion, and wherein the step of securing the expandable pouch further comprises pushing the clip toward the expandable pouch while the previously recited step of pulling the first end and second end portion away from both the input and output openings is performed.

4. A scrub brush cleaning method, for use with a scrub brush having a handle portion, and a head portion having a broad flange and bristles extending from said broad flange, in allowing the scrub brush to be used to clean a scratchable cleaning surface, using a device having an expandable pouch made of soft cloth material, the expandable pouch having an open upper end and a cinching string at said open upper end, comprising the steps of:
extending the bristles through the open upper end of the pouch;
pulling the open upper end over the broad flange of the head portion;
securing the expandable pouch onto the open upper end by pulling the string to cinch the open end above the broad flange; and
cleaning the scratchable cleaning surface with the soft cloth material.

5. The scrub brush cleaning method as recited in claim 4, wherein the open upper end of the pouch portion has a peripheral channel extending therearound, the peripheral channel having an input opening and an output opening in relative proximity to one another, the cinching string disposed within the peripheral channel of the open upper end of the expandable pouch portion, the cinching string has a first end portion extending through the input opening and traversing the peripheral channel and extending outwardly of the output opening, the cinching string having a second end portion essentially aligned with the first end portion, and wherein the step of pulling the string to cinch the open end further comprises pulling the first end and second end portion away from both the input and output openings.

6. The cloth pouch attachment for a scrub brush as set forth in claim 5 wherein the first end portion and the second end portion of the cinching string are coupled together by a clip, the clip being movable with respect to the first end portion and the second end portion whereby upward movement thereof will serve to close up the open upper end of the expandable pouch portion, and wherein the step of securing the expandable pouch further comprises pushing the clip toward the expandable pouch while the previously recited step of pulling the first end and second end portion away from both the input and output openings is performed.
